(19) United States
(12) Patent Application Publication
(10) Pub. No.: US 2026/0302540 A1
(43) Pub. Date: Oct. 1, 2026

(54) BATTERY PACK

(71) Applicant: HONDA MOTOR CO., LTD., Tokyo (JP)

(72) Inventors: Soichi MORII, Saitama (JP); Yasuo Yamada, Saitama (JP)

(73) Assignee: HONDA MOTOR CO., LTD., Tokyo (JP)

(21) Appl. No.: 19/630,468

(22) Filed: Mar. 27, 2026

(30) Foreign Application Priority Data
Mar. 28, 2025 (JP) 2025-055985

(51) Int. Cl. H01M 50/503; H01M 10/48; H01M 50/211; H01M 50/298; H01M 50/507; H01M 50/51

(52) U.S. Cl. CPC H01M 50/503; H01M 10/482; H01M 10/486; H01M 50/211; H01M 50/298; H01M 50/507; H01M 50/51

(57) ABSTRACT

A battery pack includes: a battery; a detector; and a wire harness as defined herein, the battery includes a first cell voltage terminal group and a second cell voltage terminal group, a first battery connector, and a second battery connector as defined herein, the wire harness includes a first harness connector connected to the first battery connector, and a second harness connector connected to the second battery connector, the first battery connector and the first harness connector are provided with one or more empty terminal positions where no terminal is disposed, the second battery connector and the second harness connector are provided with one or more empty terminal positions where no terminal is disposed, and a terminal arrangement in the first battery connector and the first harness connector is different from a terminal arrangement in the second battery connector and the second harness connector.

### CROSS-REFERENCE TO RELATED APPLICATION

This application is based on and claims priority under 35 USC 119 from Japanese Patent Application No. 2025-055985 filed on Mar. 28, 2025.

### TECHNICAL FIELD

The present invention relates to a battery pack.

### BACKGROUND ART

In recent years, researches and developments have been conducted on a secondary battery which contributes to improvement in energy efficiency in order to allow more people to have access to affordable, reliable, sustainable and advanced energy.

A battery module disclosed in Patent Literature 1 is a battery module to be mounted on an electric vehicle or the like and includes a laminate of a plurality of cells and a sensor apparatus for detecting a voltage of each cell. The plurality of cells are laminated such that positive electrode terminals and negative electrode terminals are inverted left and right sequentially. A positive electrode terminal of one cell adjacent in a lamination direction of the plurality of cells is connected to a negative electrode terminal of another cell by a bus bar, and the plurality of cells are connected in series by a plurality of bus bars.

One end of a voltage detection line is connected to each bus bar, and the other end of a cable that bundles a plurality of voltage detection lines is provided with a cable-side connector. The cable-side connector is connected to a first sensor-side connector provided on one side surface of the sensor apparatus, and a potential of each bus bar is received by the sensor apparatus. Typically, the sensor apparatus detects the voltage of each cell based on a potential difference between two bus bars that are adjacent to each other in an arrangement order of bus bars connected in series.

The sensor apparatus further includes a second sensor-side connector. The cable-side connector of the cable extending from another battery module is connected to the second sensor-side connector, and the sensor apparatus also detects a voltage of each cell of the other battery module.

A connector structure disclosed in Patent Literature 2 is a connector structure of an electronic control unit including a plurality of connectors as in the sensor apparatus in Patent Literature 1. A plurality of connector pairs each including a unit-side connector and a cable-side connector as a pair are each provided with a mating structure unique to each connector pair. The unit-side connector and the cable-side connector paired with each other are allowed to be mated. Meanwhile, the unit-side connector and the cable-side connector that are not paired cannot be mated since respective mating structures thereof interfere with each other. Accordingly, erroneous attachment of the unit-side connector and the cable-side connector that are not paired is prevented.

Patent Literature 1: JP6670348B

Patent Literature 2: Chinese Utility Model No. 210779164 Specification

### SUMMARY OF INVENTION

As in the connector structure disclosed in Patent Literature 2, it is possible to prevent erroneous attachment of each connector by providing a different mating structure for each connector pair in the plurality of connector pairs, but this increases cost.

An object of the present invention is to make it possible, in a battery pack in which a plurality of cells and a detection unit for detecting a voltage of each cell are connected by a wire harness, to prevent a failure of the detection unit due to erroneous attachment of a connector and to detect the erroneous attachment without increasing cost.

A battery pack of an aspect of the present invention includes:
a battery including a plurality of cells connected in series;
a detection unit configured to detect a voltage of each of the plurality of cells; and
a wire harness configured to connect the battery and the detection unit, in which the battery includes
   a first cell voltage terminal group and a second cell voltage terminal group, wherein a plurality of cell voltage terminals, which are electrically connected to a plurality of voltage detection locations that are one end and the other end of series connection of the plurality of cells and midpoint(s) between the cells adjacent to each other in a connection order, are distributed into the first cell voltage terminal group and the second cell voltage terminal group in a predetermined order from the cell voltage terminal at the one end to the cell voltage terminal at the other end,
   a first battery connector in which the first cell voltage terminal group is arranged in a pattern that maintains the predetermined order, and
   a second battery connector in which the second cell voltage terminal group is arranged in the pattern and which has the same shape as the first battery connector,
the wire harness includes
   a first harness connector connected to the first battery connector, and
   a second harness connector connected to the second battery connector,
the first battery connector and the first harness connector are provided with one or more empty terminal positions where no terminal is disposed,
the second battery connector and the second harness connector are provided with one or more empty terminal positions where no terminal is disposed,
and a terminal arrangement in the first battery connector and the first harness connector is different from a terminal arrangement in the second battery connector and the second harness connector.

A battery pack of another aspect of the present invention includes:
a battery including a plurality of cells connected in series;
a detection unit configured to detect a voltage of each of the plurality of cells; and
a wire harness configured to connect the battery and the detection unit, in which the wire harness includes
   a first cell voltage line group and a second cell voltage line group, wherein a plurality of cell voltage lines, which are electrically connected to a plurality of voltage detection locations that are one end and the other end of series connection of the plurality of cells and a midpoint between the cells adjacent to each other in a connection order, are distributed into the first cell voltage line group and the second cell voltage line group in a predetermined order from the cell voltage line at the one end to the cell voltage line at the other end,
   a first harness connector in which a first cell voltage terminal group connected to the first cell voltage line group is arranged in a pattern that maintains the predetermined order, and
   a second harness connector in which a second cell voltage terminal group connected to the second cell voltage line group is arranged in the pattern and which has the same shape as the first harness connector,
the detection unit includes
   a first unit connector connected to the first harness connector, and
   a second unit connector connected to the second harness connector,
the first harness connector and the first unit connector are provided with one or more empty terminal positions where no terminal is disposed,
the second harness connector and the second unit connector are provided with one or more empty terminal positions where no terminal is disposed, and
a terminal arrangement in the first harness connector and the first unit connector is different from a terminal arrangement in the second harness connector and the second unit connector.

According to the present invention, in a battery pack in which a plurality of cells and a detection unit for detecting a voltage of each cell are connected by a wire harness, it is possible to prevent a failure of the detection unit due to erroneous attachment of a connector and to detect the erroneous attachment without increasing cost.

### BRIEF DESCRIPTION OF DRAWINGS

FIG. 1 is a circuit diagram of an example of a battery pack for showing an embodiment of the present invention.

FIG. 2 is a perspective view schematically showing placement and connection of a plurality of cells.

FIG. 3 is a plan view schematically showing connection between a battery and a detection unit.

FIG. 4 schematically shows correct connection between the battery and a wire harness.

FIG. 5 schematically shows incorrect connection between the battery and the wire harness.

FIG. 6 schematically shows correct connection between the battery and the wire harness.

FIG. 7 schematically shows incorrect connection between the battery and the wire harness.

FIG. 8 schematically shows correct connection between the battery and the wire harness in another arrangement pattern of a connector terminal.

FIG. 9 schematically shows incorrect connection between the battery and the wire harness in the arrangement pattern of the connector terminal in FIG. 8.

FIG. 10 schematically shows correct connection between the battery and the wire harness in the arrangement pattern of the connector terminal in FIG. 8.

FIG. 11 schematically shows incorrect connection between the battery and the wire harness in the arrangement pattern of the connector terminal in FIG. 8.

FIG. 12 schematically shows correct connection between the detection unit and the wire harness.

FIG. 13 schematically shows incorrect connection between the detection unit and the wire harness.

FIG. 14 is a plan view schematically showing connection between the battery and the detection unit in another example of the battery pack.

FIG. 15 schematically shows correct connection between the battery and the wire harness.

FIG. 16 schematically shows incorrect connection between the battery and the wire harness.

### DESCRIPTION OF EMBODIMENTS

An example of a battery pack for describing an embodiment of the present invention will be described with reference to the accompanying drawings.

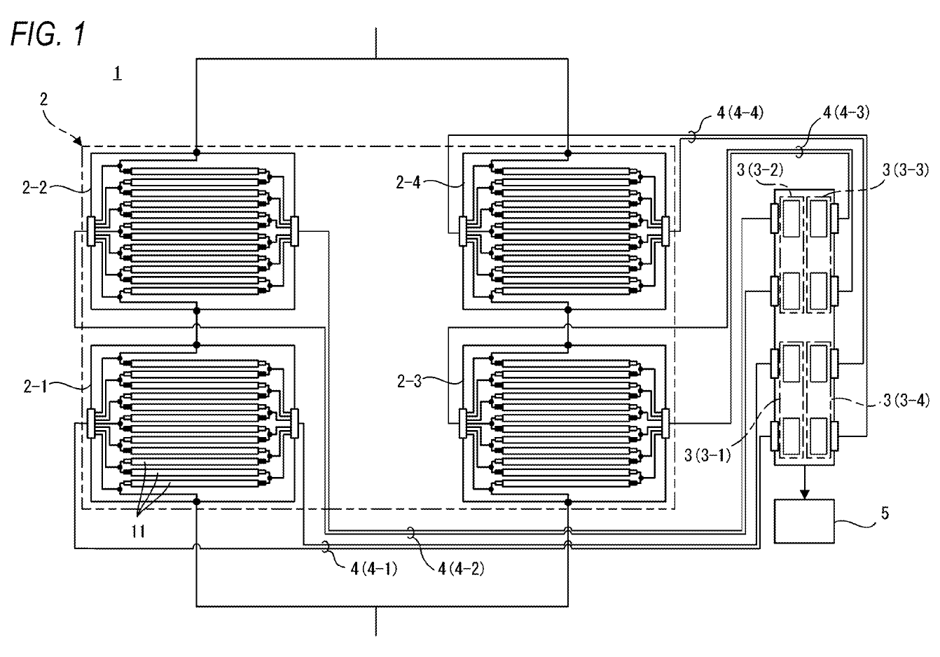

A battery pack 1 shown in FIG. 1 includes a battery 2 including a plurality of cells 11, a detection unit 3 that detects a voltage of each of the plurality of cells 11, a wiring group 4 that connects the battery 2 and the detection unit 3, and a battery electronic control unit (ECU) 5. The battery ECU 5 estimates, for example, a state of charge (SOC) of the battery 2 based on the voltage of each of the plurality of cells 11 detected by the detection unit 3.

The plurality of cells 11 are modularized, and are divided into four modules, that is, a first module 2-1, a second module 2-2, a third module 2-3, and a fourth module 2-4 in the shown example. In each module, the plurality of cells 11 are connected in series. In the shown example, the first module 2-1 and the second module 2-2 are connected in series, and the third module 2-3 and the fourth module 2-4 are also connected in series.

The detection unit 3 and the wiring group 4 are provided for each module. For example, a wiring group 4-1 for the first module 2-1 connects the first module 2-1 and the detection unit 3 for the first module 2-1. A detection unit 3-1 for the first module 2-1 detects the voltage of each cell 11 in the first module 2-1. The detection unit 3-1 for the first module 2-1, a detection unit 3-2 for the second module 2-2, a detection unit 3-3 for the third module 2-3, and a detection unit 3-4 for the fourth module 2-4 are housed in one case. The wiring group 4-1 for the first module 2-1, a wiring group 4-2 for the second module 2-2, a wiring group 4-3 for the third module 2-3, and a wiring group 4-4 for the fourth module 2-4 are appropriately bundled to form one or more wire harnesses.

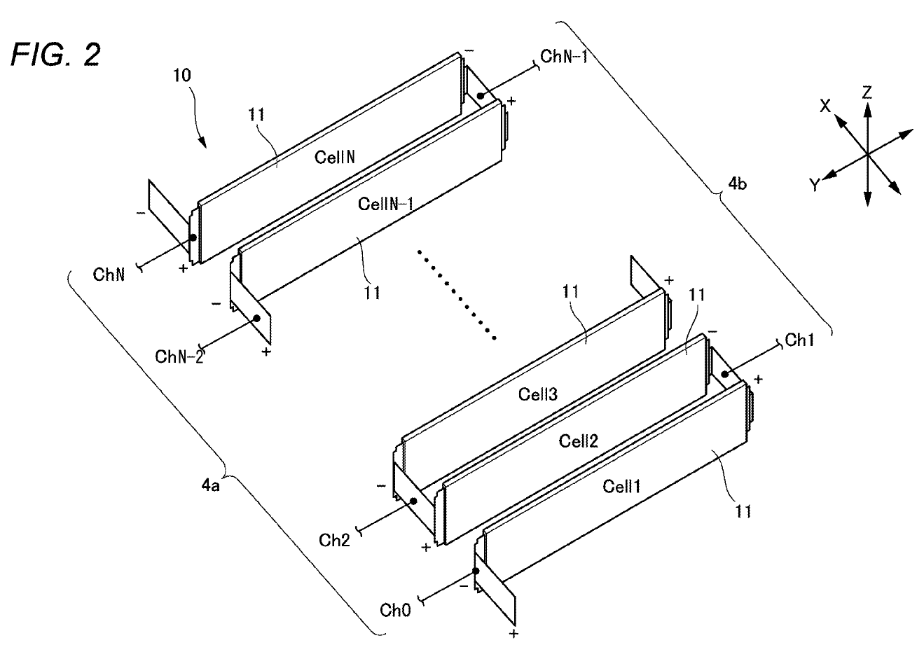

FIG. 2 shows placement and connection of the plurality of cells 11 in one module. In the example shown in FIG. 2, one module includes N cells 11, and the N cells 11 are connected in series. The number of cells is appropriately set based on a voltage required for the module.

Each cell 11 is, for example, a lithium ion battery or a nickel-metal hydride battery using a liquid electrolyte, or an all-solid-state battery using a solid electrolyte. The cell 11 shown in FIG. 2 is a so-called laminate cell in which a positive electrode, a negative electrode, a separator, and an electrolyte are sealed in a laminate film pack.

The cell 11 has a flat shape, has the positive electrode at one end in a Y direction orthogonal to an X direction that is a thickness direction, and has the negative electrode at the other end in the Y direction. The plurality of cells 11 are laminated in the X direction by aligning the Y direction of each cell and alternately inverting placement of the positive electrode and the negative electrode of each cell. In a cell laminate 10 in which the plurality of cells 11 are laminated, a positive electrode tab and a negative electrode tab of two adjacent cells 11 are directly welded, for example, and the plurality of cells 11 are connected in series.

The detection unit 3 acquires potentials of one end and the other end of the series connection of the plurality of cells 11 and a midpoint between cells adjacent to each other in a connection order. In the present example in which N cells are connected in series, the detection unit 3 detects a potential at one end as Ch0, potentials at midpoints between cells adjacent to each other in the connection order as Ch1, Ch2, ..., in order from the one end side, and a potential at the other end as ChN. Then, the detection unit 3 uses Ch0 as a reference potential, detects a voltage of a first cell on the one end side based on, for example, a potential difference between Ch0 and Ch1, and detects a voltage of a next second cell based on a potential difference between Ch1 and Ch2.

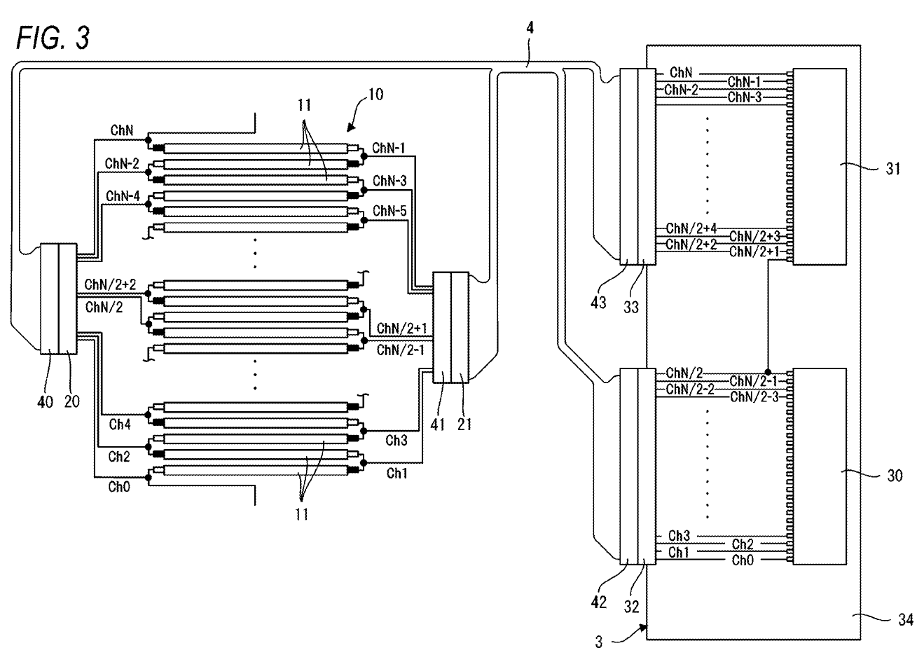

FIG. 3 shows connection between each module of the battery 2 and a corresponding detection unit. First, each module includes a first battery connector 20 and a second battery connector 21 having the same shape as the first battery connector 20. The first battery connector 20 is disposed on a first side in the Y direction of the cell laminate 10, and the second battery connector 21 is disposed on a second side in the Y direction of the cell laminate 10.

Assuming that N is an even number, potential detection locations (Ch0, Ch2, Ch4, ..., ChN) arranged every other location from Ch0 of the cell laminate 10 are located on the first side in the Y direction of the cell laminate 10. These potential detection locations (Ch0, Ch2, Ch4, ..., ChN) are electrically connected to a terminal group held by the first battery connector 20 using a wiring material such as a flexible board. Potential detection locations (Ch1, Ch3, Ch5, ..., ChN - 1) arranged every other location from Ch1 of the cell laminate 10 are located on the second side in the Y direction of the cell laminate 10. These potential detection locations (Ch1, Ch3, Ch5, ..., ChN - 1) are electrically connected to a terminal group held by the second battery connector 21 using a wiring material such as a flexible board.

The detection unit 3 includes a first integrated circuit 30, a second integrated circuit 31, and a circuit board 34 where the first integrated circuit 30 and the second integrated circuit 31 are mounted. The first integrated circuit 30 includes a plurality of terminals, and these terminals are provided aligned on an outer periphery of a package of the first integrated circuit 30. The second integrated circuit 31 also includes a plurality of terminals, and these terminals are provided aligned on an outer periphery of a package of the second integrated circuit 31.

Here, the cell laminate 10 includes N cells 11, and has N + 1 potential detection locations, that is, Ch0, Ch1, Ch2, ..., ChN. In contrast, each of the first integrated circuit 30 and the second integrated circuit 31 includes N/2 + 1 potential input terminals. Therefore, the first integrated circuit 30 receives potentials of a total of N/2 + 1 locations, that is, Ch0, Ch1, Ch2, ..., ChN/2, and the potential input terminals are arranged in order of Ch0, Ch1, Ch2, ..., ChN/2, starting from a potential input terminal where the potential of Ch0 is received. A potential input terminal of the first integrated circuit 30 where the potential of ChN/2 is received is electrically connected to one potential input terminal of the second integrated circuit 31 via a printed circuit of the circuit board 34, and the potential of ChN/2 is also received by the second integrated circuit 31. The second integrated circuit 31 receives potentials of a total of N/2 + 1 locations, that is, ChN/2, ChN/2 + 1, ChN/2 + 2, ..., ChN/2, and the potential input terminals are arranged in order of ChN/2, ChN/2 + 1, ChN/2 + 2, ..., ChN, starting from a potential input terminal where the potential of ChN/2 is received.

The detection unit 3 further includes a first unit connector 32 and a second unit connector 33 having the same shape as the first unit connector 32. The first unit connector 32 and the second unit connector 33 are mounted on the circuit board 34. Each of the potential input terminals (Ch0, Ch1, Ch2, ..., ChN/2) of the first integrated circuit 30 is electrically connected to any terminal in a terminal group held by the first unit connector 32 via the printed circuit of the circuit board 34. In addition, except for the potential input terminal where the potential of ChN/2 is received, each of the potential input terminals (ChN/2 + 1, ChN/2 + 2, ChN/2 + 3, ..., ChN) of the second integrated circuit 31 is electrically connected to any terminal in a terminal group held by the second unit connector 33 via the printed circuit of the circuit board 34.

A wire harness constituted by the wiring group 4 includes a battery-side first harness connector 40, a battery-side second harness connector 41, a unit-side first harness connector 42, and a unit-side second harness connector 43. The battery-side first harness connector 40 is connected to the first battery connector 20, and the battery-side second harness connector 41 is connected to the second battery connector 21. The unit-side first harness connector 42 is connected to the first unit connector 32, and the unit-side second harness connector 43 is connected to the second unit connector 33.

One end of each line of the wiring group 4 is connected to any terminal in a terminal group held by the battery-side first harness connector 40 or a terminal group held by the battery-side second harness connector 41. A line group for transmitting the potentials of the potential detection locations of Ch0, Ch2, Ch4, ..., ChN of the cell laminate 10 is distributed to the battery-side first harness connector 40, and a line group for transmitting the potentials of the potential detection locations of Ch1, Ch3, Ch5, ..., ChN - 1 is distributed to the battery-side second harness connector 41.

The other end of each line of the wiring group 4 is connected to any terminal in a terminal group held by the unit-side first harness connector 42 or a terminal group held by the unit-side second harness connector 43. A line group for transmitting the potentials of the potential detection locations of Ch0, Ch1, Ch2, ..., ChN/2 of the cell laminate 10 is distributed to the unit-side first harness connector 42, and a line group for transmitting the potentials of the potential detection locations of ChN/2 + 1, ChN/2 + 2, ChN/2 + 3, ..., ChN of the cell laminate 10 is distributed to the unit-side second harness connector 43.

The first battery connector 20 and the second battery connector 21 have the same shape, and thus the battery-side first harness connector 40 and the battery-side second harness connector 41 also have the same shape. Similarly, the first unit connector 32 and the second unit connector 33 have the same shape, and thus the unit-side first harness connector 42 and the unit-side second harness connector 43 also have the same shape. In this way, by using the connectors having the same shape, cost can be reduced.

However, since connectors having the same shape are used, for example, the battery-side first harness connector 40 to be connected to the first battery connector 20 can also be mated with the second battery connector 21, and the battery-side second harness connector 41 to be connected to the second battery connector 21 can also be mated with the first battery connector 20. Therefore, incorrect connection between the battery 2 and the wire harness may occur, and in the battery pack 1, a problem caused by the incorrect connection is solved based on an arrangement of terminals of each connector.

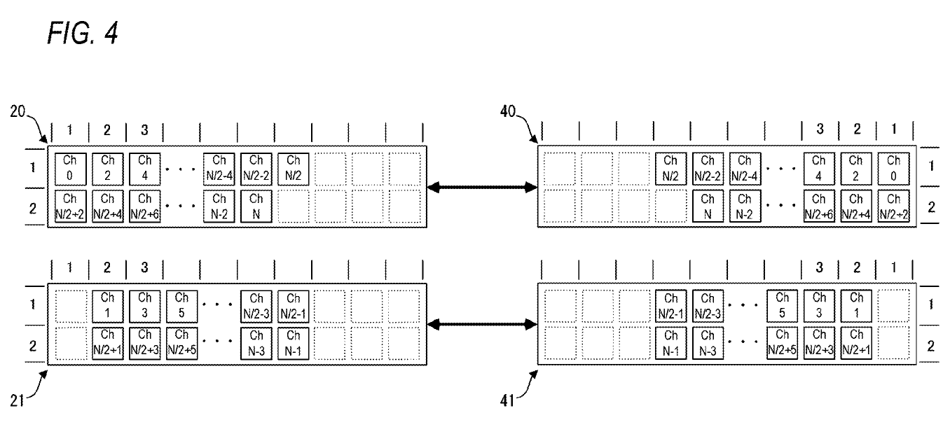

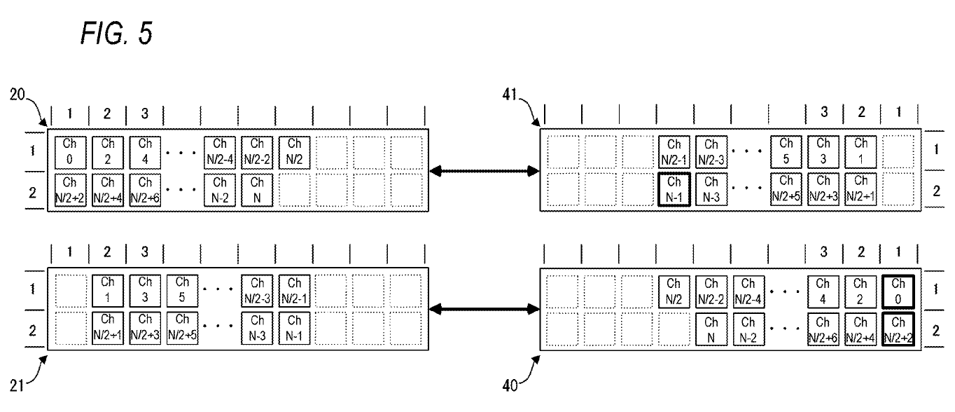

FIG. 4 shows correct connection between the battery 2 and the wire harness, and FIG. 5 shows incorrect connection between the battery 2 and the wire harness.

First, assuming that a larger number of the number of terminal groups held by the first battery connector 20 and the number of terminal groups held by the second battery connector 21 is a required number of poles, the first battery connector 20 and the second battery connector 21 each have a number of poles greater than the required number of poles. Thus, one or more empty terminal positions are provided in the first battery connector 20 and the second battery connector 21. The battery-side first harness connector 40 connected to the first battery connector 20 and the battery-side second harness connector connected to the second battery connector 21 are also provided with one or more empty terminal positions.

Each terminal group of the first battery connector 20 is arranged in a pattern that maintains the order of Ch0, Ch2, Ch4, ..., ChN. Each terminal group of the second battery connector 21 is arranged in the same pattern as the terminal group of the first battery connector 20, which maintains the order of Ch1, Ch3, Ch5, ..., ChN - 1. The terminal group of the first battery connector 20 and the terminal group of the second battery connector 21 are arranged such that a terminal arrangement (terminal group and empty terminal position) of the first battery connector 20 is different from a terminal arrangement of the second battery connector 21.

In the example shown in FIG. 4, in the first battery connector 20, terminals of Ch0, Ch2, Ch4, ..., ChN/2 are disposed in order in a first row with a first column taken as a reference, and terminals of ChN/2 + 2, ChN/2 + 4, ChN/2 + 6, ..., ChN are disposed in order in a second row. Meanwhile, in the second battery connector 21, terminals of Ch1, Ch3, Ch5, ..., ChN/2 - 1 are disposed in order in a first row with a second column taken as a reference, and terminals of ChN/2 + 1, ChN/2 + 3, ChN/2 + 5, ..., ChN - 1 are disposed in order in a second row.

A terminal arrangement of the battery-side first harness connector 40 is the same as the terminal arrangement of the first battery connector 20, and a terminal arrangement of the battery-side second harness connector 41 is the same as the terminal arrangement of the second battery connector 21.

In the correct connection shown in FIG. 4, the battery-side first harness connector 40 is connected to the first battery connector 20, and the battery-side second harness connector 41 is connected to the second battery connector 21. Accordingly, the potentials of the potential detection locations of Ch0 to ChN of the cell laminate 10 are transmitted to the corresponding potential input terminals of the first integrated circuit 30 and the second integrated circuit 31.

On the other hand, in the incorrect connection shown in FIG. 5, the battery-side second harness connector 41 is connected to the first battery connector 20, and the battery-side first harness connector 40 is connected to the second battery connector 21. In this case, a potential of a potential detection location different from the corresponding potential detection location of the cell laminate 10 is received by each potential input terminal of the first integrated circuit 30 and the second integrated circuit 31. For example, the potential of the potential detection location of Ch2 of the cell laminate 10 is received by the potential input terminal of Ch1 of the first integrated circuit 30, and the potential of the potential detection location of Ch1 is received by the potential input terminal of Ch2.

As described above, the first integrated circuit 30 and the second integrated circuit 31 detect the voltage of the cell 11 based on a potential difference between two adjacent potential input terminals (for example, Ch0 and Ch1). In this type of integrated circuit, an upper limit value for ensuring a normal operation is determined with respect to the potential difference between the two adjacent potential input terminals. Since the terminal group of the first battery connector 20 is arranged while maintaining the order of Ch0, Ch2, Ch4, ..., ChN and the terminal group of the second battery connector 21 is arranged while maintaining the order of Ch1, Ch3, Ch5, ..., ChN - 1, the potential difference between the two adjacent potential input terminals is prevented from exceeding the upper limit value even in the incorrect connection. Accordingly, it is possible to prevent a failure of the first integrated circuit 30 and the second integrated circuit 31.

The first battery connector 20 does not include a terminal connected to the terminal of ChN - 1 of the battery-side second harness connector 41, and the second battery connector 21 does not include a terminal connected to the terminals of Ch0 and ChN/2 + 2 of the battery-side first harness connector 40. As a result, no signal is received by the potential input terminal of Ch0 of the first integrated circuit 30 and the potential input terminals of ChN/2 + 2 and ChN - 1 of the second integrated circuit 31.

The first integrated circuit 30 and the second integrated circuit 31 detect the no-signal potential input terminals and transmit a detection result to the battery ECU 5. When the no-signal potential input terminals are detected, the battery ECU 5 detects the incorrect connection between the battery 2 and the wire harness, and executes notification processing such as lighting an indicator lamp. Accordingly, it is possible to allow an operator to recognize the incorrect connection and prompt resolution of the incorrect connection.

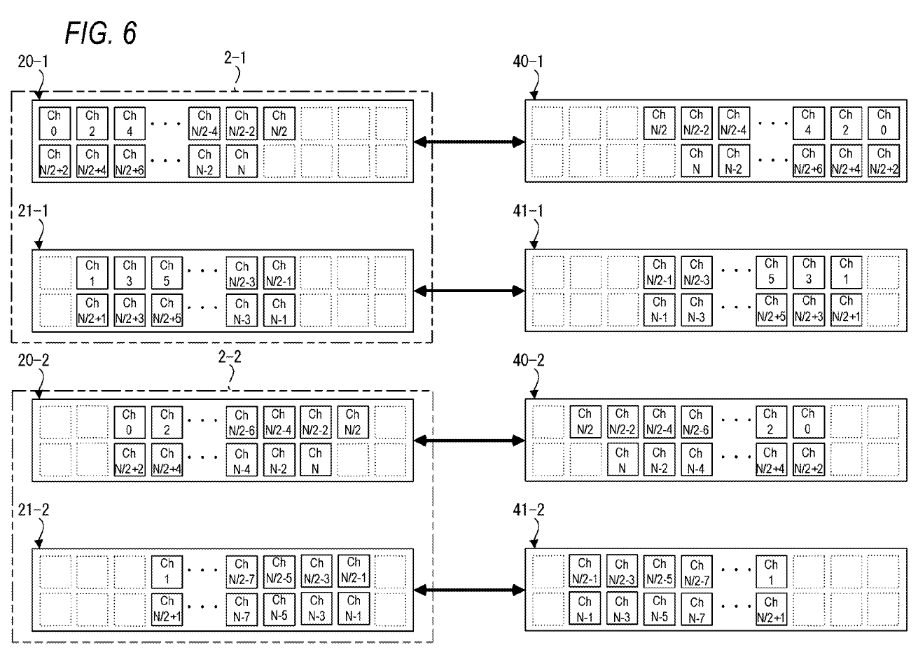

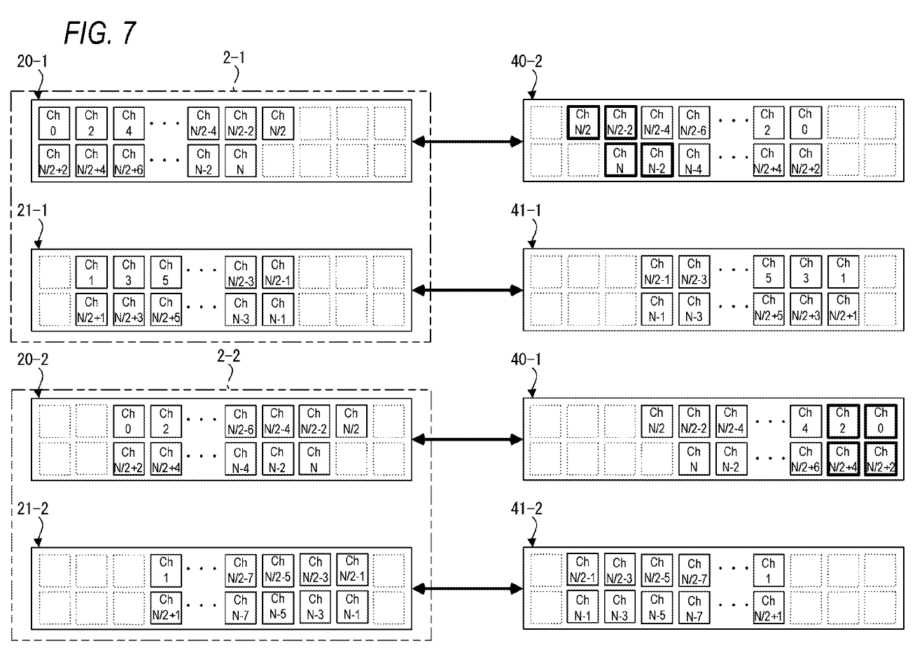

The connection examples shown in FIGS. 4 and 5 focus on one module of the battery 2, but the incorrect connection between the battery 2 and the wire harness may occur over a plurality of modules. FIG. 6 shows correct connection between the wire harness and each of the first module 2-1 and the second module 2-2, and FIG. 7 shows an example of incorrect connection between the wire harness and each of the first module 2-1 and the second module 2-2.

A first battery connector 20-1 and a second battery connector 21-1 of the first module 2-1 are formed similarly to the first battery connector 20 and the second battery connector 21 shown in FIGS. 4 and 5. A battery-side first harness connector 40-1 and a battery-side second harness connector 41-1 connected to the first battery connector 20-1 and the second battery connector 21-1 are formed similarly to the battery-side first harness connector 40 and the battery-side second harness connector 41 shown in FIGS. 4 and 5.

A first battery connector 20-2 of the second module 2-2 is formed similarly to the first battery connector 20 shown in FIGS. 4 and 5 except that a terminal arrangement thereof is different. Specifically, in the first battery connector 20-2 of the second module 2-2, terminals of Ch0, Ch2, Ch4, ..., ChN/2 are disposed in order in a first row with a third column taken as a reference, and terminals of ChN/2 + 2, ChN/2 + 4, ChN/2 + 6, ..., ChN are disposed in order in a second row.

A second battery connector 21-2 of the second module 2-2 is formed similarly to the second battery connector 21 shown in FIGS. 4 and 5 except that a terminal arrangement thereof is different. Specifically, terminals of Ch1, Ch3, Ch5, ..., ChN/2 - 1 are disposed in order in a first row with a fourth column taken as a reference, and terminals of ChN/2 + 1, ChN/2 + 3, ChN/2 + 5, ..., ChN - 1 are disposed in order in a second row.

A terminal arrangement of a battery-side first harness connector 40-2 connected to the first battery connector 20-2 is the same as the terminal arrangement of the first battery connector 20-2. A terminal arrangement of a battery-side second harness connector 41-2 connected to the second battery connector 21-2 is the same as the terminal arrangement of the second battery connector 21-2.

In the incorrect connection example shown in FIG. 7, the battery-side first harness connector 40-2 for the second module 2-2 is connected to the first battery connector 20-1 of the first module 2-1, and the battery-side first harness connector 40-1 for the first module 2-1 is connected to the first battery connector 20-2 of the second module 2-2. In this case, no signal is received by terminals of Ch0, Ch2, ChN/2 + 2, and ChN/2 + 4 of the battery-side first harness connector 40-1 for the first module 2-1, and as a result, no signal is received by potential input terminals of Ch0, Ch2, ChN/2 + 2, and ChN/2 + 4 of the first integrated circuit 30-1 and the second integrated circuit 31-1 for the first module 2-1. In addition, no signal is received by terminals of ChN/2 - 2, ChN/2, ChN - 2, and ChN of the battery-side first harness connector 40-2 for the second module 2-2, and no signal is received by potential input terminals of ChN/2 - 2, ChN/2, ChN - 2, and ChN of the first integrated circuit 30-2 and the second integrated circuit 31-2 for the second module 2-2.

Based on the no-signal potential input terminals, the battery ECU 5 detects that connection between the battery-side first harness connector 40-1 for the first module 2-1 and the battery-side first harness connector 40-2 for the second module 2-2 is incorrect, and notifies of the incorrect connection.

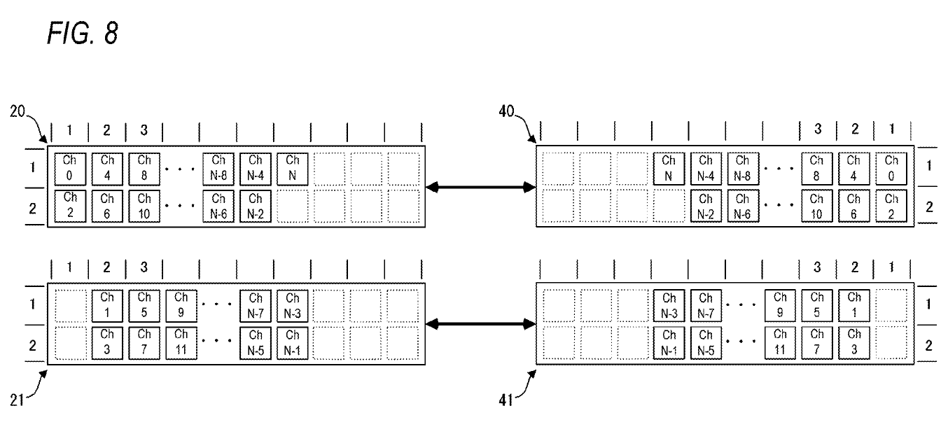

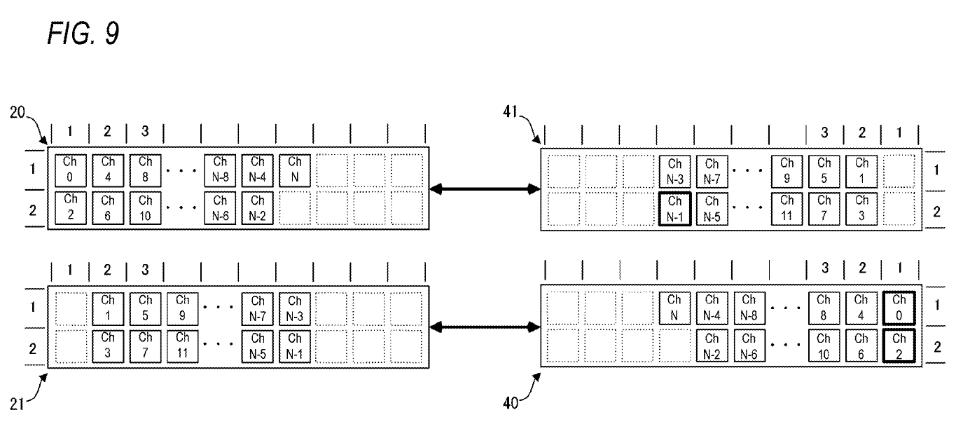

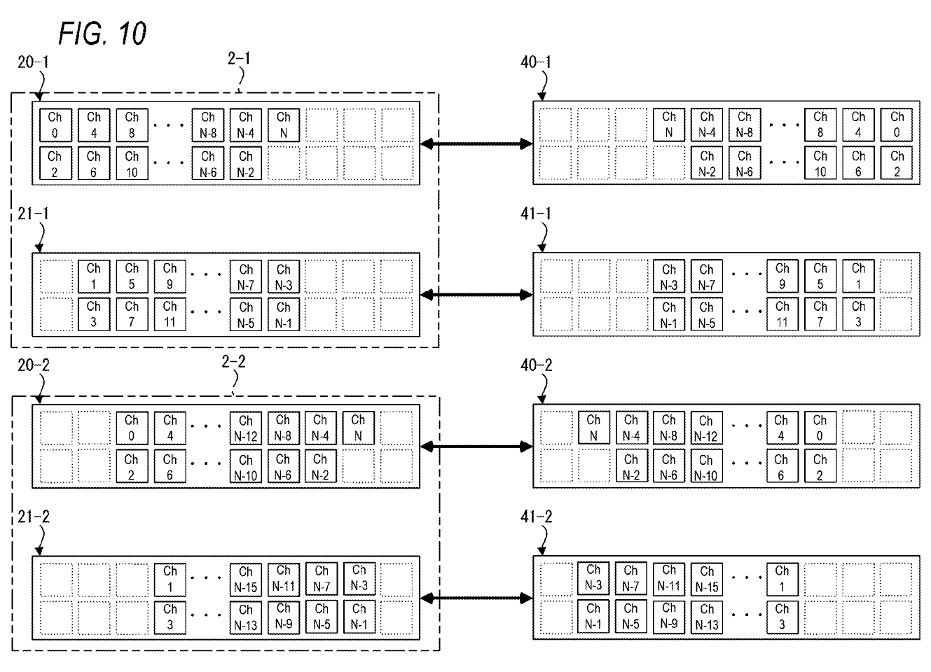

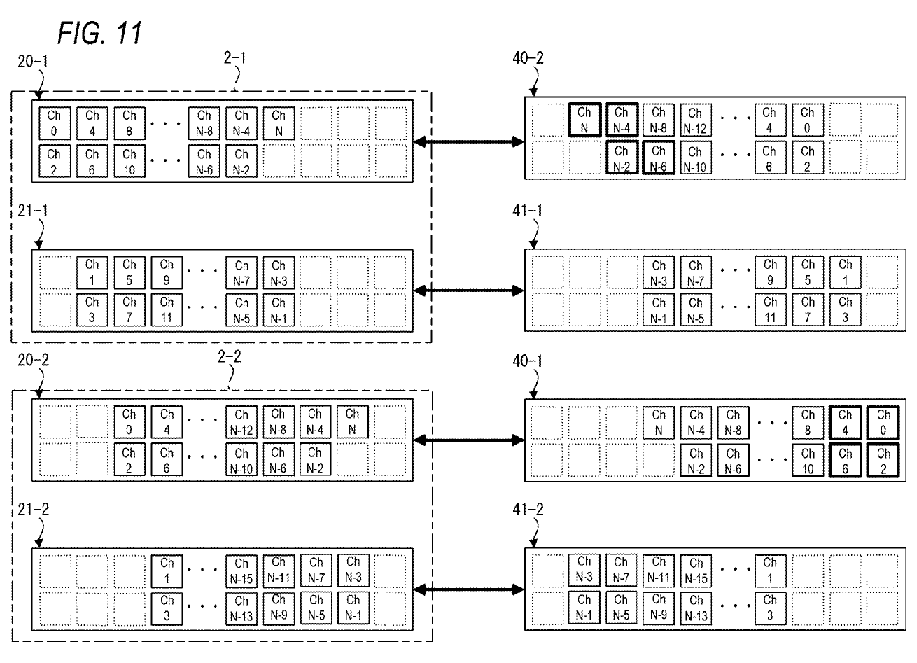

The terminal arrangement pattern is not limited to the example shown in FIG. 4 as long as the terminal group of the first battery connector 20 maintains the order of Ch0, Ch2, Ch4, ..., ChN and the terminal group of the second battery connector 21 maintains the order of Ch1, Ch3, Ch5, ..., ChN - 1. For example, as shown in FIG. 8, in the first battery connector 20, the terminals of Ch0 and Ch2 may be disposed in the first column, the terminals of Ch4 and Ch6 may be disposed in a second column, and thereafter, two terminals may be disposed in order as one set. Similarly, in the second battery connector 21, the terminals of Ch1 and Ch3 may be disposed in the second column, the terminals of Ch5 and Ch7 may be disposed in a third column, and thereafter, two terminals may be disposed in order as one set. Also in such an arrangement pattern, in incorrect connection shown in FIG. 9, no signal is received by the potential input terminals of Ch0 and Ch2 of the first integrated circuit 30 and the potential input terminal of ChN - 1 of the second integrated circuit 31, and the incorrect connection can be detected based on the no-signal potential input terminals. The terminal arrangement pattern shown in FIG. 8 is also applicable to a plurality of modules as shown in FIGS. 10 and 11. The terminal arrangement pattern shown in FIG. 8 is suitable when a back side of a connector is a terminal (board) or the like.

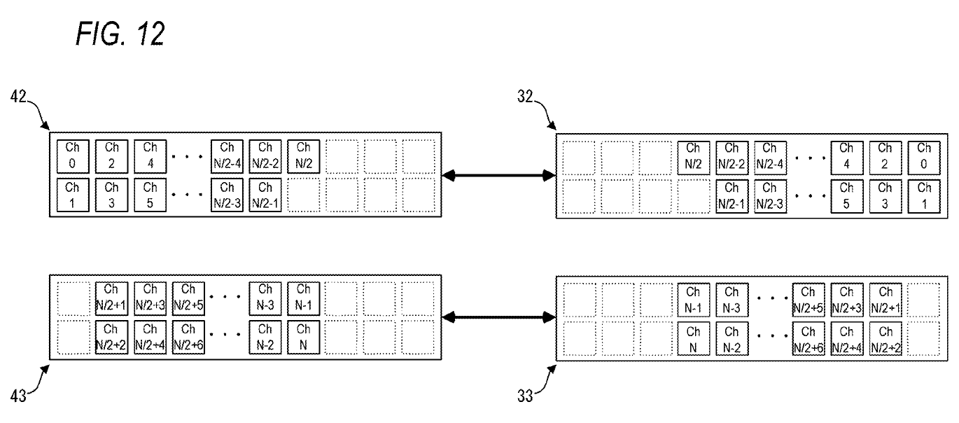

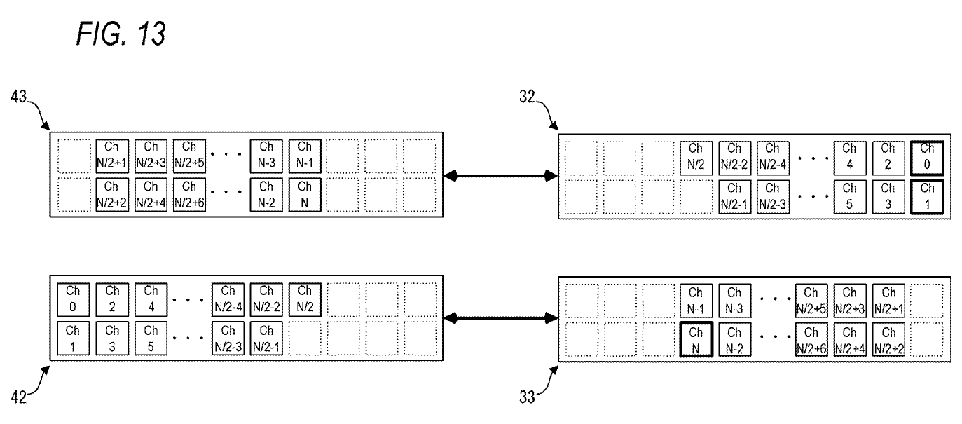

FIG. 12 shows correct connection between the wire harness and the detection unit 3, and FIG. 13 shows incorrect connection between the wire harness and the detection unit 3.

Line groups for transmitting the potentials of the potential detection locations of Ch0, Ch1, Ch2, ..., ChN/2 of the cell laminate 10 are distributed to the unit-side first harness connector 42, and terminal groups connected to these line groups are arranged while maintaining the order of Ch0, Ch1, Ch2, ..., ChN/2. Line groups for transmitting the potentials of the potential detection locations of ChN/2 + 1, ChN/2 + 2, ChN/2 + 3, ..., ChN of the cell laminate 10 are distributed to the unit-side second harness connector 43, and terminal groups connected to these line groups are arranged while maintaining the order of ChN/2 + 1, ChN/2 + 2, ChN/2 + 3, ..., ChN. Each terminal group of the unit-side first harness connector 42 and each terminal group of the unit-side second harness connector 43 are arranged such that a terminal arrangement of the unit-side first harness connector 42 is different from a terminal arrangement of the unit-side second harness connector 43.

In the example shown in FIG. 12, in the unit-side first harness connector 42, terminals of Ch0 and Ch1 are disposed in a first column, terminals of Ch2 and Ch3 are disposed in a second column, and thereafter, two terminals are disposed in order as one set. Meanwhile, in the second battery connector 21, terminals of ChN/2 + 1 and ChN/2 + 2 are disposed in a second column, terminals of ChN/2 + 3 and ChN/2 + 4 are disposed in a third column, and thereafter, two terminals are disposed in order as one set.

A terminal arrangement of the first unit connector 32 is the same as the terminal arrangement of the unit-side first harness connector 42, and a terminal arrangement of the second unit connector 33 is the same as the terminal arrangement of the unit-side second harness connector 43.

In the correct connection shown in FIG. 12, the unit-side first harness connector 42 is connected to the first unit connector 32, and the unit-side second harness connector 43 is connected to the second unit connector 33. Accordingly, the potentials of the potential detection locations of Ch0 to ChN of the cell laminate 10 are transmitted to the corresponding potential input terminals of the first integrated circuit 30 and the second integrated circuit 31.

On the other hand, in the incorrect connection shown in FIG. 13, the unit-side second harness connector 43 is connected to the first unit connector 32, and the unit-side first harness connector 42 is connected to the second unit connector 33. In this case, a potential of a potential detection location different from the corresponding potential detection location of the cell laminate 10 is received by each potential input terminal of the first integrated circuit 30 and the second integrated circuit 31, and no signal is received by a part of the potential input terminals.

However, since the terminal group of the unit-side first harness connector 42 is arranged while maintaining the order of Ch0, Ch1, Ch2, ..., ChN/2 and the terminal group of the unit-side second harness connector 43 is arranged while maintaining the order of ChN/2 + 1, ChN/2 + 2, ChN/2 + 3, ..., ChN, a potential difference between two adjacent potential input terminals is prevented from exceeding the upper limit value even in the incorrect connection. Accordingly, it is possible to prevent a failure of the first integrated circuit 30 and the second integrated circuit 31.

The first integrated circuit 30 and the second integrated circuit 31 detect the no-signal potential input terminals and transmit a detection result to the battery ECU 5. When the no-signal potential input terminals are detected, the battery ECU 5 detects the incorrect connection between the battery 2 and the wire harness, and executes notification processing such as lighting an indicator lamp. Accordingly, it is possible to allow the operator to recognize the incorrect connection and prompt resolution of the incorrect connection.

The incorrect connection between the detection unit 3 and the wire harness may occur over a plurality of modules, and similarly to the example shown in FIGS. 6 and 7, a terminal arrangement of a unit-side first harness connector 42-1 of the first module 2-1, a terminal arrangement of a unit-side second harness connector 43-1 of the first module 2-1, a terminal arrangement of a unit-side first harness connector 42-2 of the second module 2-2, and a terminal arrangement of a unit-side second harness connector 43-2 of the second module 2-2 may be different.

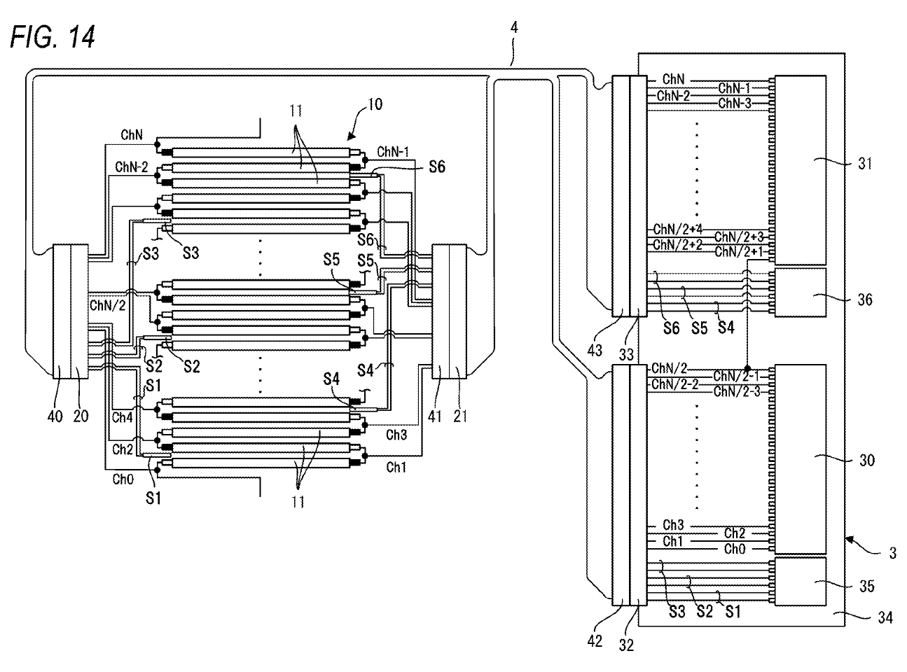

FIG. 14 shows a modification of the battery pack 1, and each module of the battery 2 includes a plurality of sensors. Each sensor is, for example, a temperature sensor for detecting a temperature of the module or a gas sensor for detecting a gas that may be generated due to deterioration of the cell 11. The sensors are disposed in a distributed manner in various places of the module.

Assuming that the sensor is a two-wire sensor, each connector of the first battery connector 20 and the second battery connector 21 further includes, as a group, a set of two sensor terminals connected to the sensor. In the example shown in FIG. 14, the first battery connector 20 includes a sensor terminal group electrically connected to sensors S1, S2, and S3. The second battery connector 21 includes a sensor terminal group electrically connected to sensors S4, S5, and S6.

The detection unit 3 detects a state of the battery such as the temperature of the module and presence or absence of the gas based on an output from the plurality of sensors. The detection unit 3 includes a third integrated circuit 35 and a fourth integrated circuit 36, an output from the sensors S1, S2, and S3 is received by the third integrated circuit 35, and an output from the sensors S4, S5, and S6 is received by the fourth integrated circuit 36.

The third integrated circuit 35 is mounted on the circuit board 34 adjacent to the first integrated circuit 30. A sensor input terminal group of the third integrated circuit 35 where the output from the sensors S1, S2, and S3 is received is electrically connected to the terminal group held by the first unit connector 32 via the printed circuit of the circuit board 34. The fourth integrated circuit 36 is mounted on the circuit board 34 adjacent to the second integrated circuit 31. A sensor input terminal group of the fourth integrated circuit 36 where the output from the sensors S4, S5, and S6 is received is electrically connected to the terminal group held by the second unit connector 33 via the printed circuit of the circuit board 34.

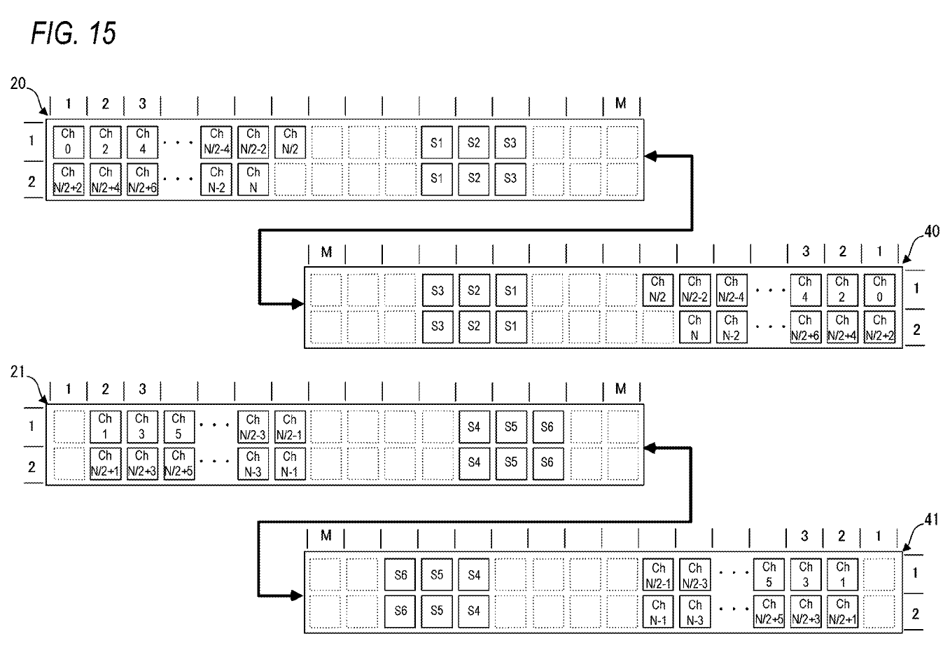

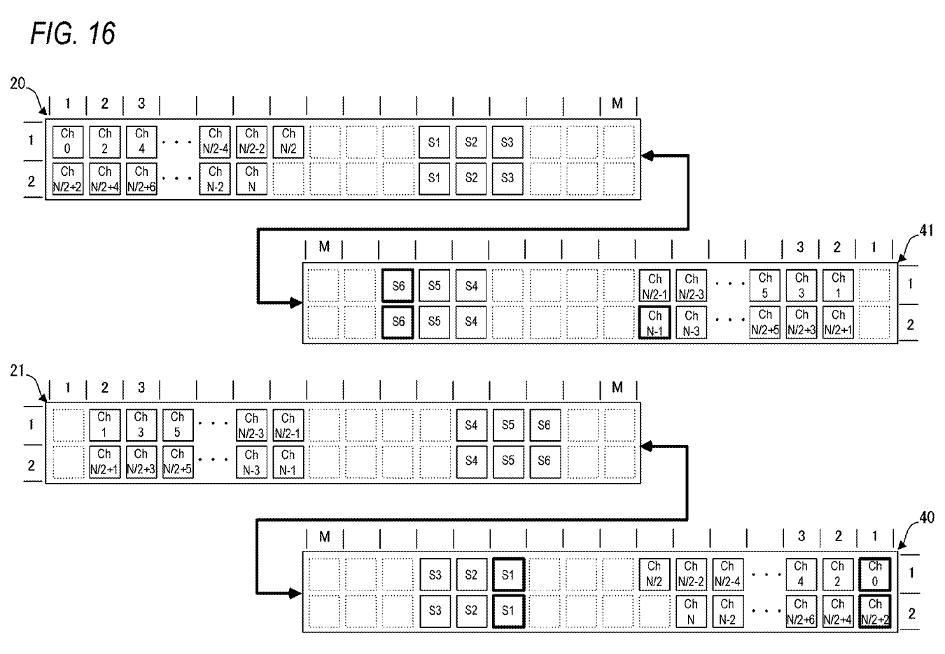

FIG. 15 shows correct connection between the battery 2 and the wire harness, and FIG. 16 shows incorrect connection between the battery 2 and the wire harness.

First, the terminal group of the first battery connector 20 includes a cell voltage terminal group electrically connected to the potential detection locations of Ch0, Ch2, Ch4, ..., ChN of the cell laminate 10, and a sensor terminal group electrically connected to the sensors S1, S2, and S3. One or more empty terminal positions are provided in the first battery connector 20. The terminal group of the second battery connector 21 includes a cell voltage terminal group electrically connected to the potential detection locations of Ch1, Ch3, Ch5, ..., ChN - 1 of the cell laminate 10, and a sensor terminal group electrically connected to the sensors S4, S5, and S6. One or more empty terminal positions are provided in the second battery connector 21.

The cell voltage terminal group of the first battery connector 20 is arranged in a pattern that maintains the order of Ch0, Ch2, Ch4, ..., ChN, and the cell voltage terminal group of the second battery connector 21 is arranged in the same pattern as the cell voltage terminal group of the first battery connector 20 while maintaining the order of Ch1, Ch3, Ch5, ..., ChN - 1. The terminal group of the first battery connector 20 and the terminal group of the second battery connector 21 are arranged such that at least a placement of the sensor terminal group in the first battery connector 20 is different from a placement of the sensor terminal group in the second battery connector 21. In the example shown in FIG. 15, assuming that a rearmost column of each of the first battery connector 20 and the second battery connector 21 is an M column, in the first battery connector 20, sensor terminal groups of S1, S2, and S3 are disposed in an (M - 5)-th column to an (M - 3)-th column. Meanwhile, in the second battery connector 21, sensor terminal groups of S4, S5, and S6 are disposed in an (M - 4)-th column to an (M - 2)-th column.

The terminal arrangement of the battery-side first harness connector 40 is the same as the terminal arrangement of the first battery connector 20, and the terminal arrangement of the battery-side second harness connector 41 is the same as the terminal arrangement of the second battery connector 21.

In the correct connection shown in FIG. 15, the battery-side first harness connector 40 is connected to the first battery connector 20, and the battery-side second harness connector 41 is connected to the second battery connector 21. Accordingly, the potentials of the potential detection locations of Ch0 to ChN of the cell laminate 10 are transmitted to the corresponding potential input terminals of the first integrated circuit 30 and the second integrated circuit 31. In addition, the output from the sensors S1 to S6 is transmitted to corresponding sensor input terminals of the third integrated circuit 35 and the fourth integrated circuit 36.

On the other hand, in the incorrect connection shown in FIG. 16, the battery-side second harness connector 41 is connected to the first battery connector 20, and the battery-side first harness connector 40 is connected to the second battery connector 21. In this case, as in the example shown in FIG. 5, the first battery connector 20 does not include a terminal connected to a cell voltage terminal of ChN - 1 of the battery-side second harness connector 41, and the second battery connector 21 does not include a terminal connected to cell voltage terminals of Ch0 and ChN/2 + 2 of the battery-side first harness connector 40. As a result, no signal is received by the potential input terminal of Ch0 of the first integrated circuit 30 and the potential input terminals of ChN/2 + 2 and ChN - 1 of the second integrated circuit 31.

The first battery connector 20 does not include a terminal connected to the sensor terminal group of S6 of the battery-side second harness connector 41, and the second battery connector 21 does not include a terminal connected to the sensor terminal group of S1 of the battery-side first harness connector 40. As a result, no signal is received by a sensor input terminal of S1 of the third integrated circuit 35 and a sensor input terminal of S6 of the fourth integrated circuit 36.

The third integrated circuit 35 and the fourth integrated circuit 36 detect the no-signal sensor input terminals and transmit a detection result to the battery ECU 5. When the no-signal sensor input terminals are detected, the battery ECU 5 detects the incorrect connection between the battery 2 and the wire harness, and executes notification processing such as lighting an indicator lamp. Accordingly, it is possible to allow the operator to recognize the incorrect connection and prompt resolution of the incorrect connection.

The embodiment of the present invention has been described above, but the present invention is not limited to the embodiment described above, and modifications, improvements, and the like can be made as appropriate. In the present specification, at least the following matters are described. Although corresponding constituent elements or the like in the embodiment described above are shown in parentheses, the present invention is not limited thereto.

(1) A battery pack including:
a battery (battery 2) including a plurality of cells (cells 11) connected in series;
a detection unit (detection unit 3) configured to detect a voltage of each of the plurality of cells; and
a wire harness (wiring group 4) configured to connect the battery and the detection unit, in which
the battery includes
   a first cell voltage terminal group and a second cell voltage terminal group, wherein a plurality of cell voltage terminals, which are electrically connected to a plurality of voltage detection locations that are one end and the other end of series connection of the plurality of cells and midpoint(s) between the cells adjacent to each other in a connection order, are distributed into the first cell voltage terminal group and the second cell voltage terminal group in a predetermined order from the cell voltage terminal at the one end to the cell voltage terminal at the other end,
   a first battery connector (first battery connector 20) in which the first cell voltage terminal group is arranged in a pattern that maintains the predetermined order, and
   a second battery connector in which the second cell voltage terminal group is arranged in the pattern and which has the same shape as the first battery connector,
the wire harness includes
   a first harness connector (battery-side first harness connector 40) connected to the first battery connector, and
   a second harness connector (battery-side second harness connector 41) connected to the second battery connector,
the first battery connector and the first harness connector are provided with one or more empty terminal positions where no terminal is disposed,
the second battery connector and the second harness connector are provided with one or more empty terminal positions where no terminal is disposed, and
a terminal arrangement in the first battery connector and the first harness connector is different from a terminal arrangement in the second battery connector and the second harness connector.

According to the battery pack of (1), since a terminal group of the first battery connector is arranged while maintaining a predetermined order and a terminal group of the second battery connector is arranged while maintaining a predetermined order, it is possible to prevent a failure of the detection unit even in incorrect connection. In addition, since the terminal arrangement of the first battery connector is different from the terminal arrangement of the second battery connector, a part of signals are not received by the detection unit in the incorrect connection, and accordingly, the detection unit can detect erroneous attachment of a connector.

(2) The battery pack according to (1), in which
the battery includes a plurality of sensors (sensors S1 to S6) for detecting a state of the battery other than a voltage,
the detection unit detects the state of the battery based on an output from the plurality of sensors,
each connector of the first battery connector and the second battery connector further includes one or more sets of sensor terminal groups connected to one or more sensors among the plurality of sensors, and
at least a placement of the one or more sets of sensor terminal groups in the first battery connector is different from a placement of the one or more sets of sensor terminal groups in the second battery connector.

According to the battery pack of (2), in the incorrect connection, an output from a part of sensors is not received by the detection unit, and the detection unit can detect erroneous attachment of a connector based on presence of an unreceived sensor output.

(3) The battery pack according to (2), in which
the plurality of sensors are temperature sensors.

(4) The battery pack according to (2), in which
the plurality of sensors are gas sensors.

(5) The battery pack according to (1), in which
each cell of the plurality of cells has a flat shape, has a positive electrode at one end in a first direction orthogonal to a thickness direction, and has a negative electrode at the other end in the first direction,
the plurality of cells are laminated in the thickness direction with the first direction of each of the cells aligned in parallel, and are laminated such that a placement of the positive electrode and the negative electrode of each of the cells is alternately inverted,
the first cell voltage terminal group is electrically connected to a voltage detection location located on a first side in the first direction of a laminate of the plurality of cells, among the plurality of voltage detection locations, and
the second cell voltage terminal group is electrically connected to a voltage detection location located on a second side opposite to the first side in the first direction of the laminate of the plurality of cells, among the plurality of voltage detection locations.

(6) A battery pack including:
a battery (battery 2) including a plurality of cells (cells 11) connected in series;
a detection unit (detection unit 3) configured to detect a voltage of each of the plurality of cells; and
a wire harness (wiring group 4) configured to connect the battery and the detection unit, in which
the wire harness includes
   a first cell voltage line group and a second cell voltage line group, wherein a plurality of cell voltage lines, which are electrically connected to a plurality of voltage detection locations that are one end and the other end of series connection of the plurality of cells and a midpoint between the cells adjacent to each other in a connection order, are distributed into the first cell voltage line group and the second cell voltage line group in a predetermined order from the cell voltage line at the one end to the cell voltage line at the other end,
   a first harness connector (unit-side first harness connector 42) in which a first cell voltage terminal group connected to the first cell voltage line group is arranged in a pattern that maintains the predetermined order, and
   a second harness connector (unit-side second harness connector 43) in which a second cell voltage terminal group connected to the second cell voltage line group is arranged in the pattern and which has the same shape as the first harness connector,
the detection unit includes
   a first unit connector (first unit connector 32) connected to the first harness connector, and a
   second unit connector (second unit connector 33) connected to the second harness connector, the first harness connector and
   the first unit connector are provided with one or more empty terminal positions where no terminal is disposed,
   the second harness connector and the second unit connector are provided with one or more empty terminal positions where no terminal is disposed, and
   a terminal arrangement in the first harness connector and the first unit connector is different from a terminal arrangement in the second harness connector and the second unit connector.

According to the battery pack of (6), since a terminal group of the first harness connector is arranged while maintaining a predetermined order and a terminal group of the second harness connector is arranged while maintaining a predetermined order, it is possible to prevent a failure of the detection unit even in incorrect connection. In addition, since the terminal arrangement of the first harness connector is different from the terminal arrangement of the second harness connector, a part of signals are not received by the detection unit in the incorrect connection, and accordingly, the detection unit can detect erroneous attachment of a connector.

(7) The battery pack according to (6), in which
the battery includes a plurality of sensors (sensors S1 to S6) for detecting a state of the battery other than a voltage,
the detection unit detects the state of the battery based on an output from the plurality of sensors,
each connector of the first harness connector and the second harness connector further includes one or more sets of sensor terminal groups electrically connected to one or more sensors among the plurality of sensors, and
at least a placement of the one or more sets of sensor terminal groups in the first harness connector is different from a placement of the one or more sets of sensor terminal groups in the second harness connector.

According to the battery pack of (7), in the incorrect connection, an output from a part of sensors is not received by the detection unit, and the detection unit can detect erroneous attachment of a connector based on presence of an unreceived sensor output.

(8) The battery pack according to (7), in which
the plurality of sensors are temperature sensors.

(9) The battery pack according to (7), in which
the plurality of sensors are gas sensors.

### REFERENCE SIGNS LIST

1: battery pack
2: battery
3: detection unit
4: wiring group
5: battery ECU
10: cell laminate
11: cell
20: first battery connector
21: second battery connector
30: first integrated circuit
31: second integrated circuit
32: first unit connector
33: second unit connector
34: circuit board
35: third integrated circuit
36: fourth integrated circuit
40: battery-side first harness connector
41: battery-side second harness connector
42: unit-side first harness connector
43: unit-side second harness connector
S1 to S6: sensors

What is claimed is:

1. A battery pack comprising:
a battery including a plurality of cells connected in series;
a detector configured to detect a voltage of each of the plurality of cells; and
a wire harness configured to connect the battery and the detector, wherein
the battery includes
a first cell voltage terminal group and a second cell voltage terminal group, wherein a plurality of cell voltage terminals, which are electrically connected to a plurality of voltage detection locations that are one end and other end of series connection of the plurality of cells and at least one midpoint between the cells adjacent to each other in an order of the series connection, are distributed into the first cell voltage terminal group and the second cell voltage terminal group in a predetermined order from the cell voltage terminal at the one end to the cell voltage terminal at the other end,
a first battery connector in which the first cell voltage terminal group is arranged in a pattern that maintains the predetermined order, and
a second battery connector in which the second cell voltage terminal group is arranged in the pattern and which has a same shape as the first battery connector,
the wire harness includes
a first harness connector connected to the first battery connector, and
a second harness connector connected to the second battery connector,
the first battery connector and the first harness connector are provided with one or more empty terminal positions where no terminal is disposed,
the second battery connector and the second harness connector are provided with one or more empty terminal positions where no terminal is disposed, and
a terminal arrangement in the first battery connector and the first harness connector is different from a terminal arrangement in the second battery connector and the second harness connector.

2. The battery pack according to claim 1, wherein
the battery includes a plurality of sensors for detecting a state of the battery other than a voltage,
the detector detects the state of the battery based on an output from the plurality of sensors,
each connector of the first battery connector and the second battery connector further includes one or more sets of sensor terminal groups connected to one or more sensors among the plurality of sensors, and
at least a placement of the one or more sets of sensor terminal groups in the first battery connector is different from a placement of the one or more sets of sensor terminal groups in the second battery connector.

3. The battery pack according to claim 2, wherein
the plurality of sensors are temperature sensors.

4. The battery pack according to claim 2, wherein
the plurality of sensors are gas sensors.

5. The battery pack according to claim 1, wherein
each cell of the plurality of cells has a flat shape, has a positive electrode at one end in a first direction orthogonal to a thickness direction of the each cell, and has a negative electrode at other end in the first direction,
the plurality of cells are laminated in the thickness direction with the first direction of each of the cells aligned in parallel, and are laminated such that a placement of the positive electrode and the negative electrode of each of the cells is alternately inverted,
the first cell voltage terminal group is electrically connected to a voltage detection location located on a first side in the first direction of a laminate of the plurality of cells, among the plurality of voltage detection locations, and
the second cell voltage terminal group is electrically connected to a voltage detection location located on a second side opposite to the first side in the first direction of the laminate of the plurality of cells, among the plurality of voltage detection locations.

6. A battery pack comprising:
a battery including a plurality of cells connected in series;
a detector configured to detect a voltage of each of the plurality of cells; and
a wire harness configured to connect the battery and the detector, wherein
the wire harness includes
a first cell voltage line group and a second cell voltage line group, wherein a plurality of cell voltage lines, which are electrically connected to a plurality of voltage detection locations that are one end and other end of series connection of the plurality of cells and at least one midpoint between the cells adjacent to each other in an order of the series connection, are distributed into the first cell voltage line group and the second cell voltage line group in a predetermined order from the cell voltage line at the one end to the cell voltage line at the other end,
a first harness connector in which a first cell voltage terminal group connected to the first cell voltage line group is arranged in a pattern that maintains the predetermined order, and
a second harness connector in which a second cell voltage terminal group connected to the second cell voltage line group is arranged in the pattern and which has a same shape as the first harness connector,
the detector includes
a first unit connector connected to the first harness connector, and
a second unit connector connected to the second harness connector,
the first harness connector and the first unit connector are provided with one or more empty terminal positions where no terminal is disposed,
the second harness connector and the second unit connector are provided with one or more empty terminal positions where no terminal is disposed, and
a terminal arrangement in the first harness connector and the first unit connector is different from a terminal arrangement in the second harness connector and the second unit connector.

7. The battery pack according to claim 6, wherein
the battery includes a plurality of sensors for detecting a state of the battery other than a voltage,
the detector detects the state of the battery based on an output from the plurality of sensors,
each connector of the first harness connector and the second harness connector further includes one or more sets of sensor terminal groups electrically connected to one or more sensors among the plurality of sensors, and
at least a placement of the one or more sets of sensor terminal groups in the first harness connector is different from a placement of the one or more sets of sensor terminal groups in the second harness connector.

8. The battery pack according to claim 7, wherein
the plurality of sensors are temperature sensors.

9. The battery pack according to claim 7, wherein
the plurality of sensors are gas sensors.
